(19) United States
(12) Patent Application Publication
(10) Pub. No.: US 2011/0272972 A1
(43) Pub. Date: Nov. 10, 2011

(54) VEHICLE BODY FRAMEWORK STRUCTURE

(75) Inventor: Taku Takayanagi, Saitama (JP)

(73) Assignee: HONDA MOTOR CO., LTD., Tokyo (JP)

(21) Appl. No.: 13/145,236

(22) PCT Filed: Dec. 18, 2009
(86) PCT No.: PCT/JP2009/071103

§ 371 Date: Jul. 19, 2011

(30) Foreign Application Priority Data
Mar. 2, 2009 (JP) 2009-048359

(51) Int. Cl. B62D 25/20

(52) U.S. Cl. 296/204

(57) ABSTRACT

A vehicle body framework structure configured in such a manner that a load is efficiently transmitted from a front side frame to a tunnel frame. A vehicle body framework structure (11) includes a frame (54) formed by joining an end (58) of a second frame (51) to an end (57) of a first frame (47). The frame has a rectangular closed cross-sectional shape. A first extension section (64) formed at the end of the first frame (47) is superposed on and joined to the outer surface of the end (58) of the second frame (51). A second extension (71) formed at the end (58) of the second frame is superposed on and joined to the outer surface of an end (62) of the first frame (47).

### TECHNICAL FIELD

The present invention relates to a skeletal structure of a vehicle body for dispersing a load applied to a front side of the vehicle body.

### BACKGROUND ART

Skeletal structures of vehicle bodies include reinforcing members attached to projecting center tunnels disposed between driver's seats and passenger seats. One of these skeletal structures includes a dash cross member interconnecting rear ends of front portions of left and right side frames which support front suspensions, and two laterally spaced-apart connection frames having front ends connected to the dash cross member, as disclosed in Patent Literature 1 below.

The dash cross member has difficulty transmitting to the connection frames a load applied to the left and right side frames. Namely, the load can not be efficiently transmitted to the connection frames because the front ends of the connection frames disposed along a center tunnel are connected to a rearward-facing side surface of the dash cross member.

If two elongated members of closed cross-section such as the connection frames are to be welded end to end, the elongated members need to butt against each other before they are welded. In so doing, the elongated members should be positioned at the same level. This butting operation would require a long time.

Additionally, it is difficult to form a groove uniformly throughout a perimeter of a butting area where the respective ends of the elongated member butt against each other. If a groove is not formed uniformly along the perimeter of the butting area, the elongated members would be welded together along a perimeter shorter than the entire perimeter of the butting area.

### PRIOR ART LITERATURE

### Patent Literature

Patent Literature 1: JP 10-264846A

### SUMMARY OF INVENTION

### Technical Problem

An object of the present invention is to provide a skeletal structure of a vehicle body designed to achieve improved efficient transmission of a load from front side frames to tunnel frame members, which structure includes first and second closed-cross-sectional frames assembled together in a simple manner and having their end portions welded together throughout perimeters of the end portions.

### Solution to Problem

According to one aspect of the present invention, there is provided a skeletal structure of a vehicle body, the structure comprising a frame assembly including: a first frame having a closed cross-section of substantially rectangular shape; a second frame having a closed cross-section of substantially rectangular shape; the first frame including an end portion, the second frame including an end portion, the end portion of the first frame being joined to the end portion of the second frame; the end portion of the first frame having one side and an opposite side, the one side of the end portion of the first frame having an end of L-shaped cross-section and a first L-shaped extension extending from the end of L-shaped cross-section, the opposite side of the end portion of the first frame having an end of L-shaped cross-section; the end portion of the second frame having one side and an opposite side, the one side of the end portion of the second frame having an end of L-shaped cross-section, the opposite side of the end portion of the second frame having an end and a second L-shaped extension extending from the end of the opposite side of the end portion of the second frame; the first L-shaped extension of the one side of the end portion of the first frame lying on and joined to an outer surface of the end of the one side of the end portion of the second frame; the second L-shaped extension of the opposite side of the end portion of the second frame lying on and joined to an outer surface of the end of the opposite side of the end portion of the first frame.

In a preferred form of the present invention, the vehicle body has an underbody defining a floor of the vehicle body, and a front body including left and right front side frames contiguous with the underbody, the underbody including a center tunnel, and wherein the frame assembly is disposed on the underbody, the first frame comprising a dash cross member contiguous with one of the left and right front side frames, the second frame comprising a tunnel frame member disposed on the center tunnel.

In a further preferred form of the present invention, the vehicle body has an underbody defining a floor of the vehicle body, the underbody including an upright bulkhead disposed at a front part thereof, the bulkhead including a dashboard lower panel, the first frame including a first member having flanges at opposite edges thereof and a second member having flanges at opposite edges thereof, the flanges of the first member being joined to the flanges of the second member to form the closed cross-section of substantially rectangular shape, the flanges of the first member and the flanges of the second member lying on and joined to the dashboard lower panel.

In a further preferred form of the present invention, the end of the opposite side of the end portion of first frame has a slanted corner portion while the end of the one side of the end portion of the second frame has a slanted corner portion.

### ADVANTAGEOUS EFFECTS OF INVENTION

The one side of the end portion of the first frame has the end of L-shaped cross-section and the first L-shaped extension extending from the end of L-shaped cross-section. The first L-shaped extension of the one side of the end portion of the first frame lies on and is joined to an outer surface of the end of the one side of the end portion of the second frame. The second L-shaped extension of the opposite side of the end portion of the second frame lies on and is joined to an outer surface of the end of the opposite side of the end portion of the first frame. The first frame and the second frame can be easily assembled together by vertically moving one of the first and second frames towards the other, for example, by lowering the second frame towards the first frame located below the second frame in such a manner that the second frame lies on the first extension while the second extension lies on the first frame. After the second frame is lowered, the second frame may be moved slightly from side to side to allow the first and second frames to be assembled together.

After the first and second frames are assembled together, the first and second extensions are joined to the second frame and the first frame, respectively, by joining means such as welding or rivets. By joining the first and second extensions to the second and first frames, the first and second frames are joined together along substantially the entire perimeters of the frames.

The frame assembly is disposed on the underbody. The first frame comprises the dash cross members contiguous with the left and right front side frames of the front body contiguous with the underbody while the second frame comprises the tunnel frame members disposed on the center tunnel. The dash cross members extend toward an engine compartment side of the front body through the dashboard panel providing the bulkhead and contiguous with the front side of the underbody. The dash cross members allow for improved efficiency of transmission of a load from the front side frames to the tunnel frame members.

The first frame includes a first member having flanges at opposite edges thereof and a second member having flanges at opposite edges thereof. The flanges of the first member are joined to the flanges of the second member to form the closed cross-section of substantially rectangular shape. The flanges of the first member and the flanges of the second member lie on and are joined to the dashboard lower panel. When a load is applied directly to front side frames of a front body of the vehicle body, the first and second members can disperse the load into the dashboard lower panel and then throughout the dashboard panel.

The end of the opposite side of the end portion of first frame has the slanted corner portion while the end of the one side of the end portion of the second frame has the slanted corner portion. In fitting the second frame to the first frame to assemble them together, the second frame is moved downwardly to the first frame located below the second frame to allow the first and second extensions to lie on the second and first frames, respectively. In so doing, the first extension is guided by the slanted corner portion of the second frame while the second extension is guided by the slanted corner portion of the first frame. The slanted corner portions guide the first and second extensions in this manner to thereby facilitate the operation of fitting the second frame to the first frame.

### BRIEF DESCRIPTION OF DRAWINGS

FIG. 1 is a perspective view of a vehicle body including a skeletal structure according to an embodiment of the present invention;

FIG. 2 is a bottom view of the vehicle body shown in FIG. 1;

FIG. 3 is an enlarge view of an region indicated by reference numeral 3 of FIG. 1;

FIG. 4 is a cross-sectional view taken along line 4-4 of FIG. 3;

FIG. 5 is a perspective view of the skeletal structure according to the embodiment of the present invention;

FIG. 6 is a perspective of a frame assembly of the skeletal structure shown in

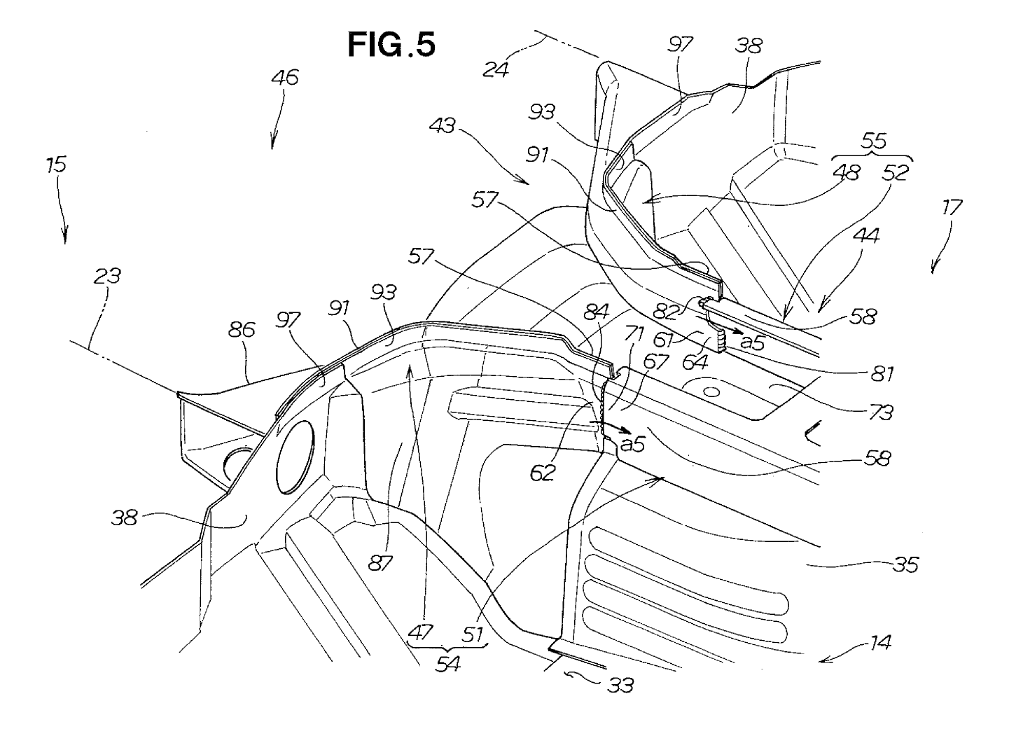

FIG. 5;

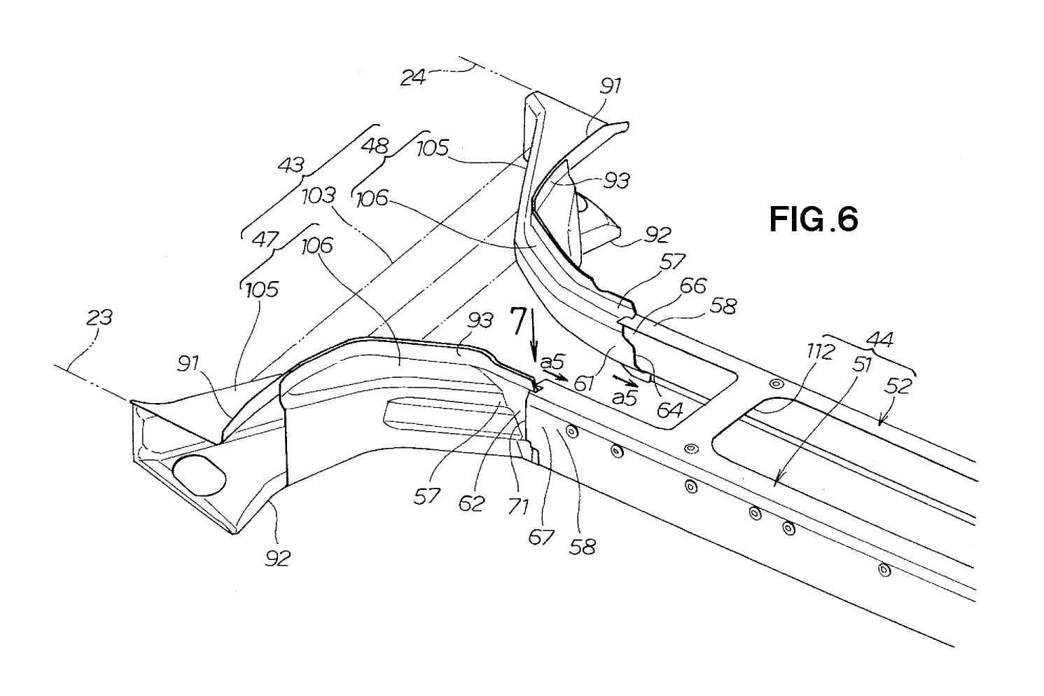

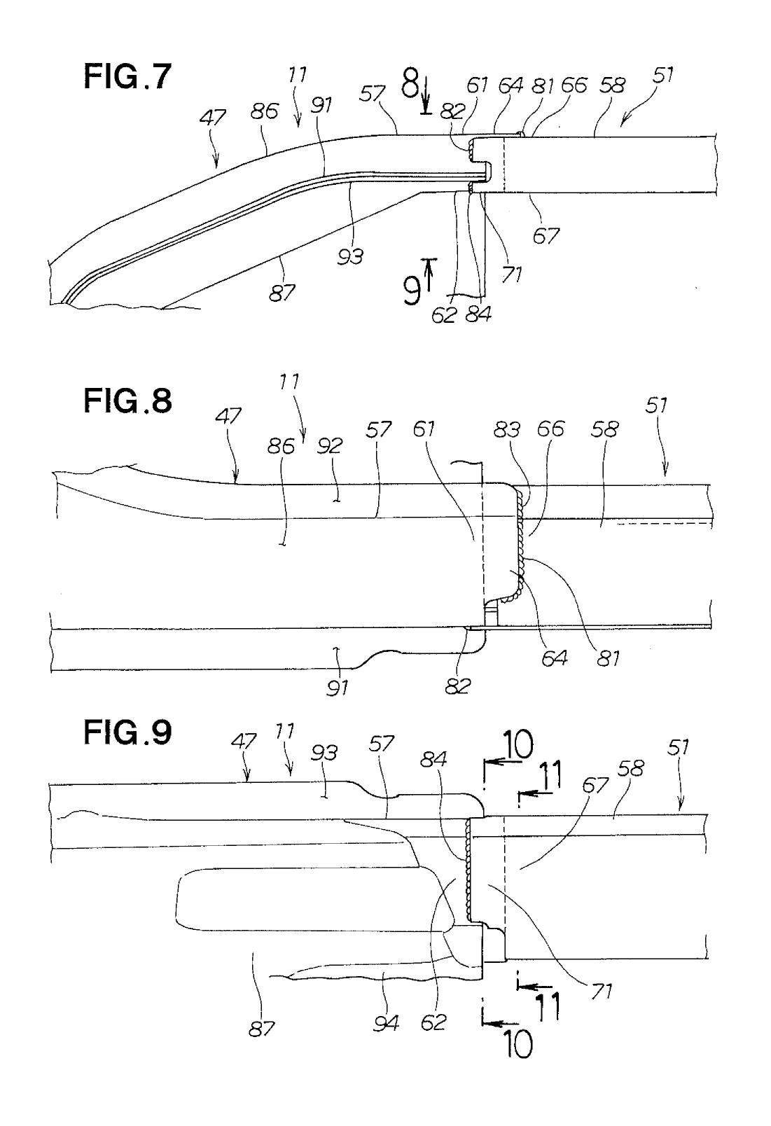

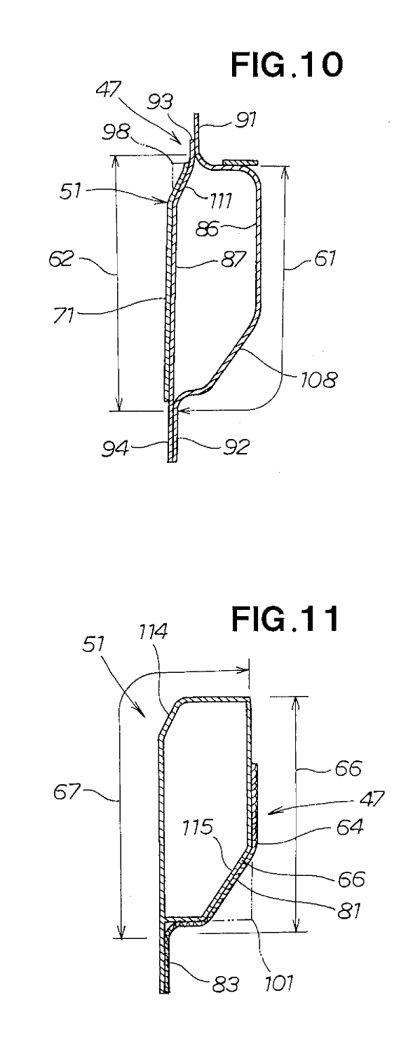

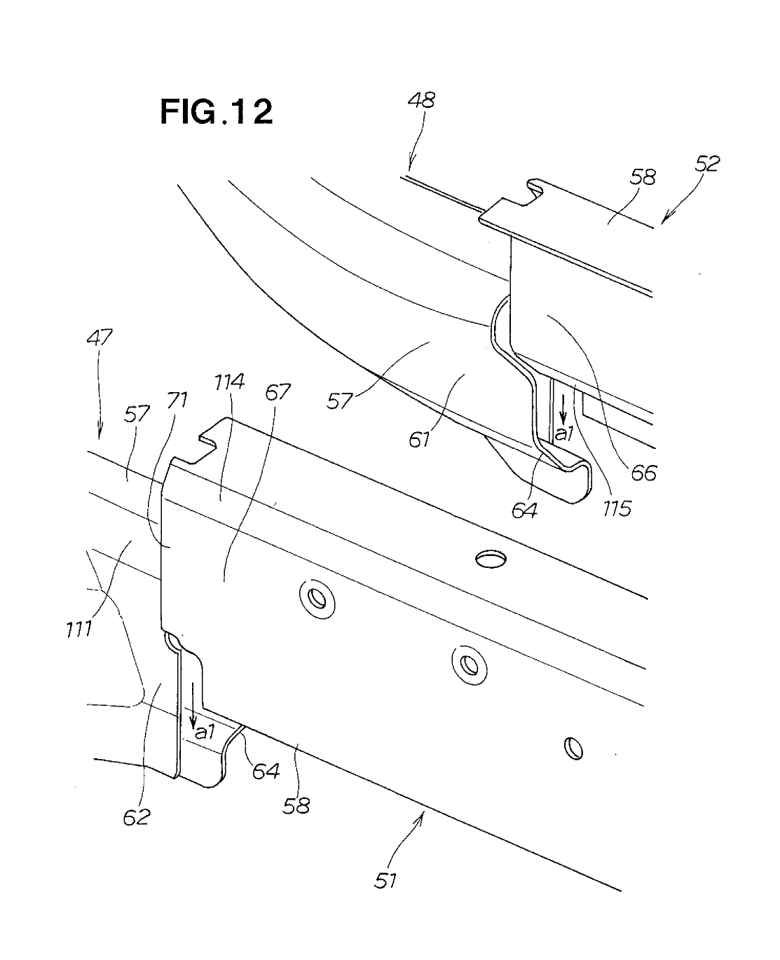

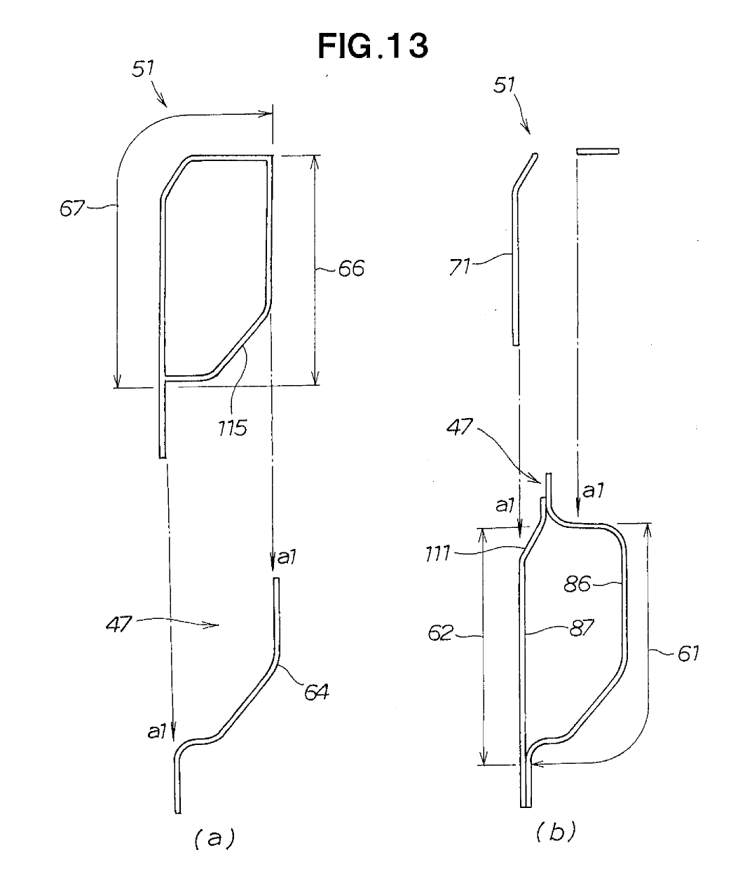

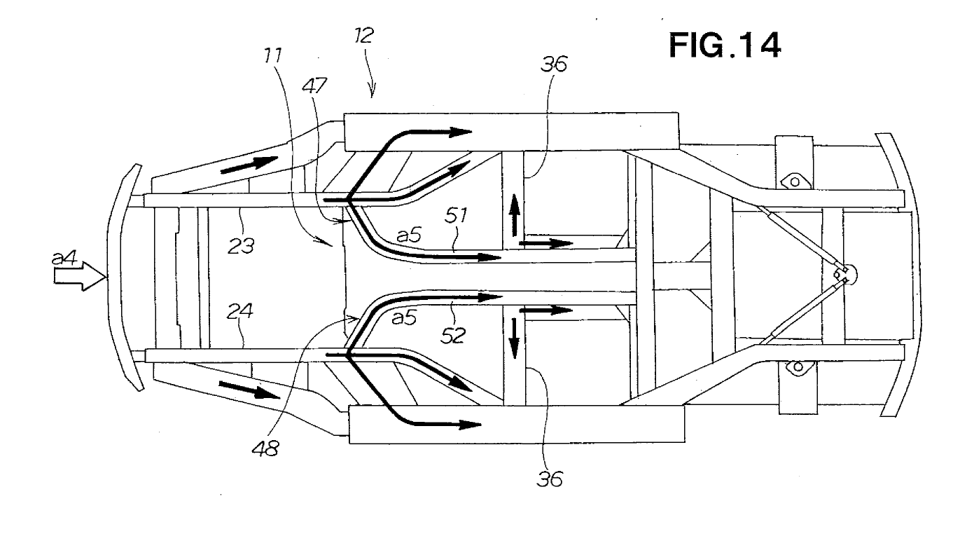

FIG. 7 is a view showing the skeletal structure when viewed in a direction of reference numeral 7 of FIG. 6;

FIG. 8 is a view showing the skeletal structure when viewed in a direction of reference numeral 8 of FIG. 7;

FIG. 9 is a view showing the skeletal structure when viewed in a direction of reference numeral 9 of FIG. 7;

FIG. 10 is a cross-sectional view taken along line 10-10 of FIG. 9;

FIG. 11 is a cross-sectional view taken along line 11-11 of FIG. 9;

FIG. 12 is a perspective view showing how to assemble the frame assembly of the skeletal structure;

FIG. 13 is a view showing how to assemble together first and second frames of the frame assembly shown in FIG. 12; and

FIG. 14 is a view of the skeletal structure dispersing a load applied to a front side of a vehicle.

### MODE FOR CARRYING OUT THE INVENTION

A certain preferred embodiment of the present invention is described below with reference to the accompanying drawings.

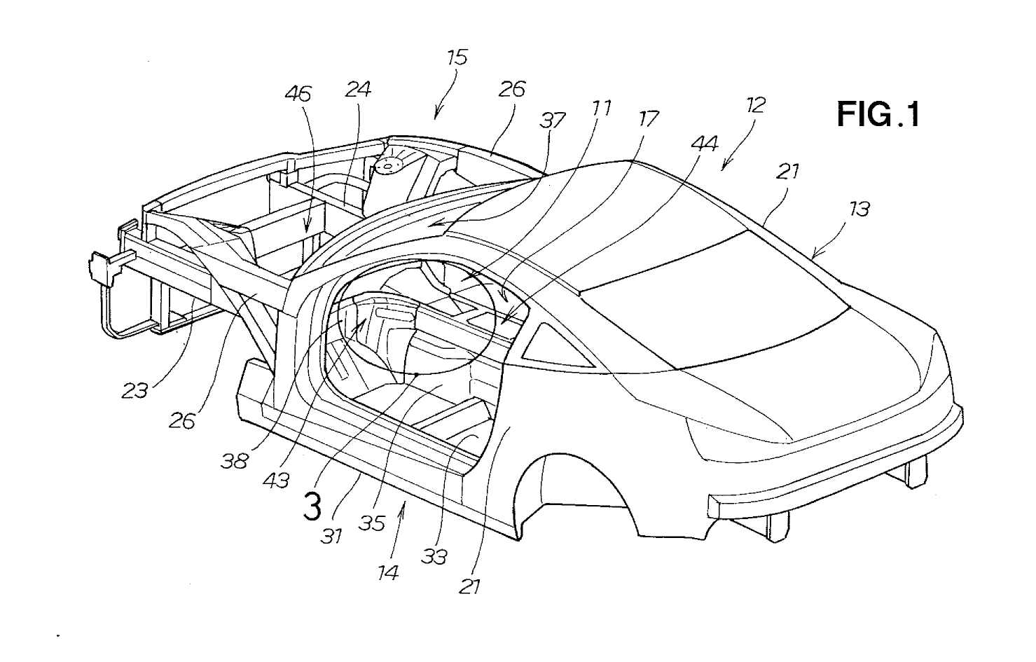

Referring to FIG. 1, there is shown a vehicle 12 including a skeletal structure 11 of the present invention. The skeletal structure 11 is disposed between an underbody 14 defining a floor of a vehicle body 13 of the vehicle and a front body 15 disposed forward of the underbody 14. The front body 15 is configured to allow a load applied thereto to be dispersed to the underbody 14.

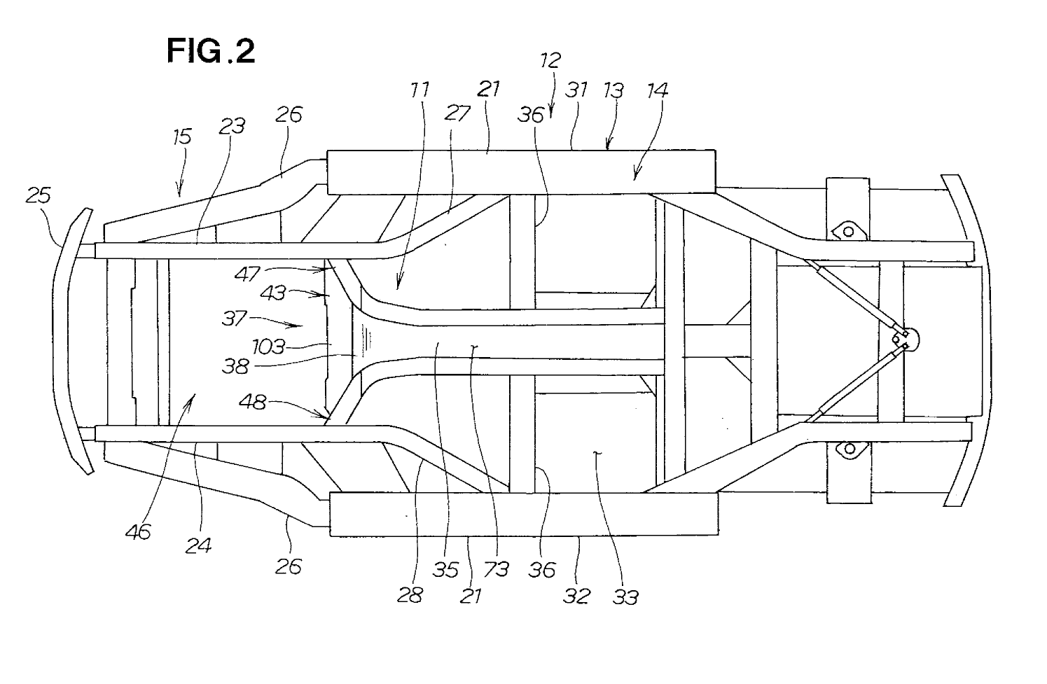

The vehicle body 13 includes the underbody 14 including a floor of a passenger compartment 17, the front body 15, and left and right side bodies 21. As shown in FIGS. 1 and 2, the front body 15 includes left and right front side frames 23, 24, a bumper beam 25 interconnecting front ends of the left and right front side frames 23, 24, and left and right upper frames 26, 26 disposed above the left and right front side frames 23, 24, respectively and contiguous with the left and right side bodies 21, respectively.

As shown in FIGS. 1 to 3, the under body 14 includes left and right front floor frames 27, 28, left and right side sills 31, 32, a floor panel 33, a center tunnel 35, left and right floor cross members 36, a dashboard panel 37, and a tunnel reinforcing member 41. The left and right front floor frames 27, 28 are contiguous with rear portions of the left and right front side frames 23, 24, respectively. The left and right side sills 31, 32 are contiguous with rear ends of the front floor frames 27, 28, respectively. The floor panel 33 extends from one of the left and right side sills 31, 32 to the other one. The center tunnel 35 is disposed on a middle of the width of the floor panel 33 and extends in a front-and-rear direction of the vehicle body. The center tunnel 35 projects inwardly of the passenger compartment 17. The right floor cross member 36 extends from one of the right side sill 31 and the center tunnel 35 to the other one while the left floor cross member 36 extends from one of the left side sill 32 and the center tunnel 35 to the other one. The dashboard panel 37 serves as a bulkhead separating the underbody 14 from the front body 15. The tunnel reinforcing member 41 is contiguous with a dashboard lower panel 38 defining a lower part of the dashboard panel 37 and disposed on a front side of the center tunnel 35.

Secured between the left and right side frames 23, 24 is a dash cross member structure 43 as discussed hereinafter. Connected to the dash cross member 43 is a tunnel frame structure 44, which will be discussed hereinafter.

As shown in FIGS. 1, 3 and 5, the dash cross member structure 43 is located in the vicinity of the left and right front side frames 23, 24. The dash cross member structure 43 is attached to a surface of the dashboard lower panel 38, which surface faces towards an engine compartment 46. The dash cross member structure 43 is connected to the tunnel frame structure 44 and extends through a middle of the width of the dash board panel 37 into the passenger compartment 17.

The dash cross member structure 43 includes left and right dash cross members (first frame) 47, 48. The tunnel frame structure 44 includes left and right tunnel frame members (second frame) 51, 52. The left dash cross member 47 is joined to the left tunnel frame member 51 while the right dash cross member 48 is joined to the right tunnel frame member 52. The left dash cross member 47 and the left tunnel frame member 51 define a left frame assembly 54. The right dash cross member 48 and the right tunnel frame member 52 define a right frame assembly 55. These frame assemblies 54, 55 form the skeletal structure 11 of the present invention.

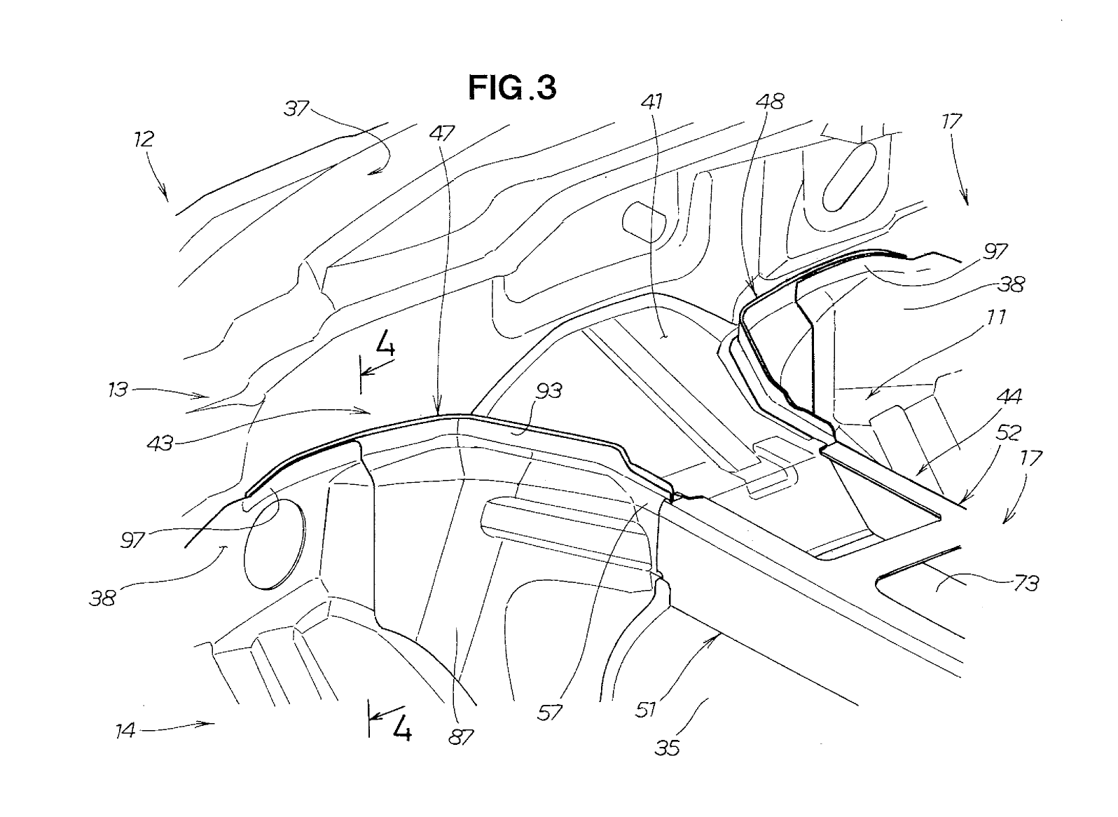

As shown in FIGS. 3 to 6, the dash cross member 47 of the left frame assembly 54 has an end portion 57 joined to an end portion 58 of the tunnel frame member 51. As shown in FIG. 10, the dash cross member 47 has a generally rectangular closed cross-section. As shown in FIG. 11, the tunnel frame member 51 has a generally rectangular closed cross-section. The right frame assembly 55 is in symmetrical relation to the left frame assembly 54 about the center tunnel 35.

The end portion 57 of the dash cross member 47 has an end 61 of L-shaped cross-section on one side thereof and an end 62 of L-shaped cross-section on an opposite side thereof. The end portion 57 has also a first extension 64 of L-shape on the one side. The first extension 64 extends from the end 61. The end portion 58 of the tunnel frame member 51 has an end 66 of L-shaped cross-section on one side thereof. The first extension 64 of the end portion 57 of the dash cross member 47 lies on and is joined to an outer surface of the end 66 of the end portion 58 of the tunnel frame member 51.

The end portion 58 of the tunnel frame member 51 has an end 67 on an opposite side thereof. On the opposite side of the end portion 58, the end portion 58 has a second extension 71 of L-shape extending from the end 67. The second extension 71 lies on and is joined to an outer surface of the end 62.

As shown in FIG. 5, the left and right frame assemblies 54, 55 are disposed on the underbody 14 defining the floor of the vehicle body 13. The dash cross member 47 is contiguous with the left front side frame 23 of the front body 15 contiguous with the underbody 14. Similarly, the dash cross member 48 is contiguous with the right front side frame 24. The tunnel frame member 51 is disposed leftward of a top portion 73 of the center tunnel 35 of the underbody 14. The tunnel frame member 52 is disposed rightward of the top portion 73.

The dash cross member 47 is coupled to the tunnel frame member 51 through a first weld bead 81, a second weld bead 82, a third weld bead 83 and a fourth weld bead 84 all of which are shown in FIGS. 7 to 9.

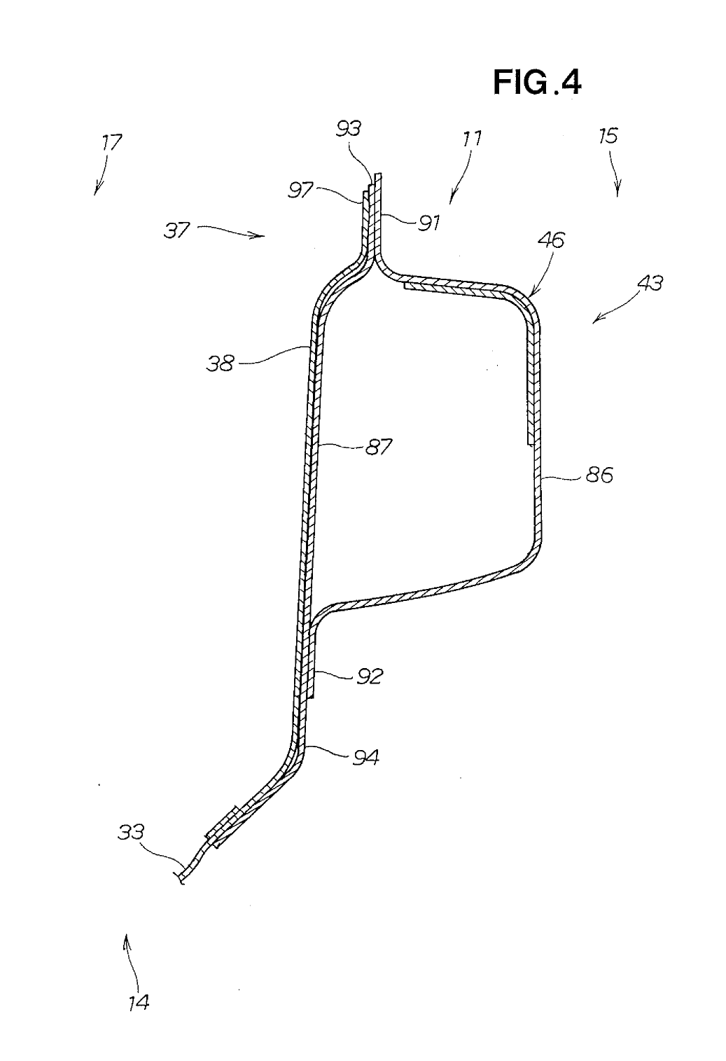

Reference is made to FIGS. 4 to 6 and 10. The dash cross member 47 is formed by first and second members 86, 87. The first member 86 has first and second flanges 91, 92 at opposite edges thereof. The second member 87 has third and fourth flanges 93, 94 at opposite edges thereof. The first flange 91 and the second flange 92 are joined to the third flange 93 and the fourth flange 94, respectively, to form the closed cross-section of the dash cross member 47. The flanges 91, 92, 93, 94 lie on and are joined to the dashboard lower panel 38 of the upright bulkhead (dashboard panel 37) disposed at a front part of the underbody 14, as shown in FIGS. 3 to 5. The first flange 91 is joined to an opened end 97 of the dashboard lower panel 38. The second flange 92 has the first extension 64 including its edge joined to the tunnel frame member 51 through the third weld bead 83.

The end 62 of the opposite side of the end portion 57 of the dash cross member 47 has a corner portion 98 (shown by a phantom line in FIG. 10) which is formed to provide a slant. The end 66 of the one side of the end portion 58 of the tunnel frame member 51 has a corner portion 101 (shown by a phantom line in FIG. 11) which is formed to provide a slant.

Discussion will be made as to the left dash cross member 47 and the left tunnel frame member 51.

As shown in FIGS. 2 and 6, the dash cross member structure 43 has opposite ends joined to the left and right front side frames 23, 24. More specifically, as shown in FIGS. 4 to 6, the dash cross member structure 43 includes the left dash cross member 47 joined directly to the left front side frame 23, the right dash cross member 48 joined directly to the right front side frame 24, and a central dash cross member 103 disposed between the left dash cross member 47 and the left dash cross member 48.

The left dash cross member 47 extends in the form of an arc from the front side frame 23 to the top portion 73 of the center tunnel 35, as shown in FIGS. 5 and 6. The dash cross member 47 includes a triangular cross member portion 105 extending from the front side frame 23 in a direction transverse to the front side frame 23. The dash cross member 47 further includes a connection 106 contiguous with the cross member portion 105 and connected to the top portion 73 of the center tunnel 35. The dash cross member 47 includes the first and second members 86, 87 coupled together to define the generally rectangular closed cross-section, as discussed hereinbefore.

The right dash cross member 48 has the same structure as that of the left dash cross member 47.

The first member 86 has a U-shape cross-section, as shown in FIG. 10. The first member 86 has its corner formed to provide a slanted inner side portion 108. The slanted inner side 108 of the first member 86 is formed by, for example, plastic forming of an aluminum alloy sheet.

The second member 87 has the slanted corner portion 98 acting as an outer guide portion 111. The slanted outer guide portion 111 is formed by, for example, plastic forming of an aluminum alloy sheet.

As shown in FIGS. 5 and 6, the tunnel frame structure 44 includes the left tunnel frame member 51, the right tunnel frame member 52, and a plate portion 112 interconnecting the tunnel frame members 51, 52. The tunnel frame structure 44 is carried on and joined to the top portion 73 of the center tunnel 35, and has substantially the same length as that of the center tunnel 35.

The left tunnel frame member 51 has diagonally opposed corners which are formed to provide a slanted outer side portion 114, and a slanted inner guide portion 115, as shown in FIGS. 11 and 12. The tunnel frame member 51 is formed by, for example, extruding aluminum alloy in such a manner as to form a closed cross-section and provide the slanted outer side portion 114 and the slanted inner guide portion 115.

Reference is made to FIGS. 12, 13(a) and 13(b) showing exemplary steps for manufacturing the skeletal structure 11 in accordance with the present invention. FIG. 13(a) corresponds to FIG. 11 while FIG. 13(b) corresponds to FIG. 10. It will be appreciated that the steps may be performed in order different than that as will be discussed below.

First, the left tunnel frame member 51 and the left dash cross member 47 are assembled together while the right tunnel frame member 52 and the right dash cross member 48 are assembled together. More specifically, with the dash cross members 47, 48 held by an assemblage jig (not shown), the tunnel frame members 51, 52 are fitted to the dash cross members 47, 48, respectively, by moving the frames 51, 52 downwardly, as shown by arrows al, and then the tunnel frame members 51, 52 are moved horizontally (from side to side) to allow the end portions 57, 58 to lie on the first and second extensions 64, 71, respectively. In so doing, the slanted inner guide portion 115 of each of the tunnel frame members 51, 52 is guided by the first extension 64 while the slanted outer guide portion 111 of each of the dash cross members 47, 48 guides the second extension 71.

Subsequently, the tunnel frame members 51, 52 are held by an assemblage jig. Then, the dash cross members 47, 48 are welded (fillet-welded) to the tunnel frame members 51, 52. It is to be noted that the plate portion 112 may be welded to the left and right tunnel frame members 51, 52 (FIG. 6). Finally, the welds between the dash cross member and the tunnel frame member are cooled to a normal temperature by slow cooling process, after which the tunnel frame members 51, 52 are released from the jig.

As discussed above, the tunnel frame members 51, 52 are set on the dash cross members 47, 48 by moving the frames 51, 52 vertically or horizontally, to assemble the tunnel frame members and the dash cross members together. With the dash cross member and the tunnel frame member assembled together, the dash cross member and the tunnel frame member are welded at their end portions 57, 58 together substantially throughout the perimeters of the end portions 57, 58 to thereby form the skeletal structure 11. Therefore, it becomes possible to easily manufacture the skeletal structure 11 with the improved strength.

The skeletal structure 11 can disperse a load in a manner as will be discussed with reference to FIGS. 5, 6 and 14. FIG. 14 corresponds to FIG. 2

The skeletal structure 11 is designed such that when a load is applied from another vehicle or obstructions through a front side of the vehicle 12, as shown by an arrow a4 of FIG. 14, to the front side frames 23, 24, the load is transmitted to the tunnel frame members 51, 52 by means of the dash cross members 47, 48, as shown by arrows a5 of FIGS. 5, 6 and 14.

The load can be transmitted from the front side frames 23, 24 to the tunnel frame members 51, 52 with increased efficiency because the skeletal structure 11 has its closed cross-sectional structure extending from the front side frames 23, 24 to the tunnel frame members 51, 52 in a direction of transmission of the load.

The tunnel frame members 51, 52 can disperse the load, transmitted thereto, to the floor cross member 36, 36 through the center tunnel 35.

Although the skeletal structure 11 has been described as a structure including a junction between the end portion of the dash cross member and the end portion of the tunnel frame member, the skeletal structure 11 may join members together other than the dash cross member and the tunnel frame member.

### INDUSTRIAL APPLICABILITY

The skeletal structure of the present invention is suitable for transmitting a load from front side frames to a center (center tunnel) at a middle of a width of a vehicle.

### REFERENCE NUMERAL LIST

10 vehicle
13 vehicle body
14 underbody
15 front body
23 left front side frame
24 right front side frame
35 center tunnel
37 bulkhead (dashboard panel)
38 dashboard lower panel
47 first frame (dash cross member)
48 first frame (dash cross member)
51 second frame (left tunnel frame member)
52 second frame (right tunnel frame member)
54 left frame assembly
55 right frame assembly
57 end portion of the first frame
58 end portion of the second frame
61 L-shaped end of one side of the end portion of the first frame
62 L-shaped end of opposite side of the end portion of the first frame
64 first extension
66 L-shaped end of one side of the end portion of the second frame
67 end of opposite side of the end portion of the second frame
71 second extension
86 first member
87 second member
91 first flange
92 second flange
93 third flange
94 fourth flange
98 corner of the end of opposite side of the end portion of the first frame
101 corner of the end of the one side of the end portion of the second frame

1. A skeletal structure of a vehicle body, the structure comprising a frame assembly including:
a first frame having a closed cross-section of substantially rectangular shape;
a second frame having a closed cross-section of substantially rectangular shape;
the first frame including an end portion, the second frame including an end portion, the end portion of the first frame being joined to the end portion of the second frame;
the end portion of the first frame having one side and an opposite side, the one side of the end portion of the first frame having an end of L-shaped cross-section and a first L-shaped extension extending from the end of L-shaped cross-section, the opposite side of the end portion of the first frame having an end of L-shaped cross-section;
the end portion of the second frame having one side and an opposite side, the one side of the end portion of the second frame having an end of L-shaped cross-section, the opposite side of the end portion of the second frame having an end and a second L-shaped extension extending from the end of the opposite side of the end portion of the second frame;
the first L-shaped extension of the one side of the end portion of the first frame lying on and joined to an outer surface of the end of the one side of the end portion of the second frame;
the second L-shaped extension of the opposite side of the end portion of the second frame lying on and joined to an outer surface of the end of the opposite side of the end portion of the first frame;
the vehicle body having an underbody defining a floor of the vehicle body and a front body including left and right front side frames contiguous with the underbody, the underbody including a center tunnel;
the frame assembly being disposed on the underbody, the first frame comprising a dash cross member contiguous with one of the left and right front side frames, the second frame comprising an extruded tunnel frame member disposed on the center tunnel;
the underbody including an upright bulkhead disposed at a front part thereof, the bulkhead including a dashboard lower panel; and
the first frame including a first member having flanges at opposite edges thereof and a second member having flanges at opposite edges thereof, the flanges of the first member being joined to the flanges of the second member to form the closed cross-section of substantially rectangular shape, the flanges of the first member and the flanges of the second member lying on and joined to the dashboard lower panel.

2. (canceled)

3. (canceled)

4. The skeletal structure of claim 1, wherein the end of the opposite side of the end portion of first frame has a slanted corner portion while the end of the one side of the end portion of the second frame has a slanted corner portion.
